(19) United States
(12) Patent Application Publication
(10) Pub. No.: US 2010/0147712 A1
(43) Pub. Date: Jun. 17, 2010

(54) ADAPTABLE CARRIER-TYPE CASE TO STORE AND CARRY ONE OR MORE SURF BOARDS WITH OR WITHOUT KEELS

(76) Inventors: Francisco Jose Rocha Villaca Filho, Rio de Janeiro (BR); Roberto De Abreu Martins, Rio de Janeiro (BR)

Correspondence Address: BROOKS KUSHMAN P.C., 1000 TOWN CENTER, TWENTY-SECOND FLOOR, SOUTHFIELD, MI, 48075, US

(21) Appl. No.: 12/600,694

(22) PCT Filed: May 19, 2008
(86) PCT No.: PCT/BR2008/000144

§ 371 Date: Nov. 18, 2009

(30) Foreign Application Priority Data
May 18, 2007 (BR) PI0702293-0

(51) Int. Cl. B65D 81/02; B65D 85/00; B60R 9/08; B60R 9/055

(52) U.S. Cl. 206/315.1; 206/522; 224/319

(57) ABSTRACT

This invention refers to a carrier-like case to store and carry boards. Such case is adaptable to store different types of boards with or without keels, or both types together. The referred case features a plastic or rubber inner lining which can be inflated providing safe protection during transportation of boards, therefore avoiding risk of breaking or damaging the boards. Such inner lining can be removed to be used separated from the case shell. The case to store and carry boards also allow moving around as a travel suitcase, since it is provided with a pair of wheels and a supporting handle. Additionally, the case subject matter of this invention is provided with a fitting system to be used on car racks.

The subject matter of this invention is a case to store and carry surf boards that can also be used to carry kitesurf and windsurf boards and, more precisely, it is an adaptable carrier type case provided with a fitting system for size and thickness.

### BACKGROUND OF THE INVENTION

Considering the fact that moving surf, windsurf and kitesurf boards around in local and international trips is very common in the search for different conditions for the practice of surf and similar sports, whether professionally or just for pleasure, the carrier-type case was developed with two linings as we explain herein.

In the prior art concept, there are cases to store boards that feature elements to protect the boards against damages, such as quilted linings and inflatable quilted linings made of several materials, such as fabrics or foams to protect the board, as it can be seen, for example, in the North American patent application US 2005/0023177, published on Feb. 3, 2005. However, the linings of the cases in the prior art concept allow only the storage of one board. Even when the storage of more than one board inside the same case is possible, such boards will not be properly protected since their surfaces will be in direct contact against each other, resulting in attrition during transportation therefore causing damages to the boards.

As a consequence, there is the need of a carrier-type case for boards, which is able to accommodate boards of different types or sizes with or without keels, or in both types of safety modes, that is, without the risk of breaking or scratching the boards during transportation or storage.

### SUMMARY OF THE INVENTION

This invention is intended to provide an adaptable carrier-type case to store and carry at least one board with or without keels composed of two linings, being the inner lining made of inflatable rubber and adaptable to the type and size of the board.

Another purpose of this invention is providing a case featuring a hybrid characteristic allowing the isolated use of just the inner part made of inflatable rubber, therefore providing the user with another use choice for the case.

This invention also intends to eliminate the need to use elastic extenders, which are very common to fasten boards on car racks, in view that the case subject matter of this invention provides an adaptable fitting system on the case to be used on the car racks.

The purpose of this invention is also allowing the user to leave the case permanently attached to the rack as BAG THULE®, therefore this invention's design provided a lock which allows the removal and placement of the boards without having to take the case off the car rack.

Another purpose of this invention is providing in the back part of the case a bag made of synthetic fabric to store small, but important accessories, such as paraffin wax, ropes, scrapers, etc.

This invention also intends to provide the user with an easy-to-use case to carry boards. In order to fulfill such purpose, the case, subject matter of this invention, is equipped with a pair of PVC wheels allowing it to be moved supported by a handle made of ABS rigid plastic.

### BRIEF DESCRIPTION OF THE DRAWINGS

The invention becomes clearer by the description of the following illustrations:

FIG. 1 is a view from the back of the case to store and carry boards, pursuant to this invention;

FIG. 2 is a view from the inner lining of thickness fitting of the case viewed in FIG. 1; and

FIG. 3 is a view from the top of the case to store and carry boards, pursuant to this invention.

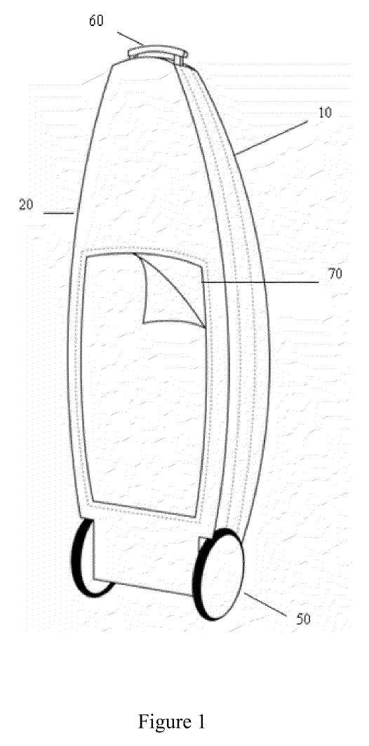

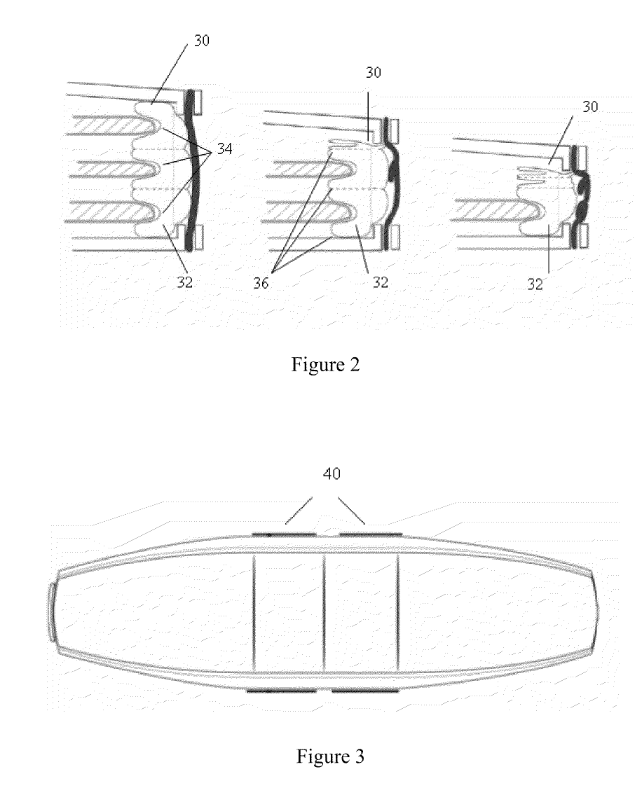

### DETAILED DESCRIPTION OF THE PREFERRED EMBODIMENT

This invention refers to an adaptable carrier-type case generally represented by the number reference (10) to store and carry surf, kitesurf or windsurf boards, which is composed of an outer part (20) and an inner part (30). Its outer part (20) is made of ABS rigid plastic or Polyvinyl Chloride (PVC) which can carry the boards safely avoiding breaking the keels and the appearance of dents on the boards. The inner part (30) is composed of a plastic or inflatable rubber lining (32) with cavities (34) to accommodate the boards and protuberances (36) to keep them at a pre-established space between themselves. Such lining can be inflated manually or by using an air-pump (not shown). The lining (30) reinforces safety against possible damages which may be caused during transportation and storage of the boards. The case to store and carry boards (10) allow transportation of up to 3 (three) boards with keels or up to 5 (five) boards without keels and features in its outer part (20) a fitting mechanism (40) made of plates that fit into grooves that allow increasing or decreasing its length and width. Such versatility provides a close-fitted accommodation of the boards inside the case (10), therefore preventing attrition between the boards, which could cause damages to the boards, such as scratches, dents or even rupture of their parts. The case to store and carry boards has also a fitting system that allows attaching it to a car rack providing safety during transportation and, optionally, its railing can be permanently in fixed mode on the top of the car.

The case to store and carry boards (10) is also provided with a pair of wheels (50) and a supporting handle (60) allowing it to be moved around as a travel carrier, providing the user with more comfort on the road.

The inner lining (30) is made of plastic or inflatable rubber and can be detached from the case shell creating a hybrid characteristic for the case subject matter of this invention, since when the inner lining (32) is detached from the inner part (30), such lining can be used separately and independently from the outer part made of rigid material (PVC or ABS), therefore characterizing the versatility of the carrier-like case which can also be used as a plain rubber case, giving it the usefulness of two products in a single one.

It is to be understood that the described embodiment of the invention are illustrative only and that modifications thereof may occur to those skilled in the art. Accordingly, this invention is not to be regarded as limited to the embodiments disclosed, but is to be limited only as defined by the appended claims.

1. A carrier-type case to store and carry surf, kitesurf or windsurf boards, comprising of an outer part made of rigid ABC plastic or Polyvinyl Chloride (PVC) and an inner part made of a plastic or inflatable rubber lining featuring cavities to accommodate the boards and protuberances and keep them spaced between themselves; such lining is removable in order to allow the hybrid use of the referred case; the case has a fitting mechanism made of plates that fit into grooves allowing increasing or decreasing the length or width, therefore providing the accommodation of up to three boards with keels and up to five boards without keels.

2. A carrier-type case, according to claim 1, comprising a pair of wheels and a supporting handle.

3. A carrier-type case, according to claim 1, comprising a fitting system that allows attaching the referred case to a car rack.

4. A carrier-type case, according to claim 1, comprising a bag made of synthetic fabric on the back surface of the referred case.

5. A carrier-type case, according to claim 2, comprising a fitting system that allows attaching the referred case to a car rack.

6. A carrier-type case, according to claim 5, comprising a bag made of synthetic fabric on the back surface of the referred case.

7. A carrier-type case, according to claim 2, comprising a bag made of synthetic fabric on the back surface of the referred case.

8. A carrier-type case, according to claim 3, comprising a bag made of synthetic fabric on the back surface of the referred case.

9. A carrier-type case to store and carry surf, kitesurf or windsurf boards, comprising of an outer part made of rigid plastic or and an inner part made of a plastic or inflatable rubber lining featuring cavities to accommodate the boards and protuberances and keep them spaced between themselves; such lining is removable in order to allow the hybrid use of the referred case; the case has a fitting mechanism made of plates that fit into grooves allowing increasing or decreasing the length or width, therefore providing the accommodation of up to three boards with keels and up to five boards without keels.
